(19) United States
(12) Patent Application Publication
(10) Pub. No.: US 2005/0004980 A1
(43) Pub. Date: Jan. 6, 2005

(54) Portable data communication device with server interface

(76) Inventor: Andrew Vadjinia, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 10/910,693

(22) Filed: Aug. 2, 2004

Related U.S. Application Data
(63) Continuation of application No. 10/146,425, filed on May 14, 2002, now abandoned.

(51) Int. Cl. G06F 15/16; G06F 17/60

(52) U.S. Cl. 709/203; 705/26

(57) ABSTRACT

A method and apparatus for providing product information to and collecting information from a user of an information display device is disclosed. In one embodiment, the disclosed method and apparatus is configured to operate in conjunction with a data server. In such an embodiment electronic hardware and software are configured to provide information to a user via a portable display device that may communicate with a main server via a wireless link. In one embodiment content is downloaded from a hub server that may additionally be configured to facilitate inventory tracking and product ordering. In other embodiments the disclosed method and apparatus may be configured with a personal feature so that a user may establish personalized information.

### RELATED APPLICATION

This application is a continuation of U.S. patent application Ser. No. 10/146,425, filed May 14, 2002.

### FIELD OF THE INVENTION

The present invention relates to information communication and processing system and in particular to a method and apparatus for data distribution, collection, and analysis.

### BACKGROUND OF THE INVENTION

The popularity of wine and spirits have existed through concatenate out the years. Today, there exists a variety of different types of wines and spirits and the variety and complexity is continuing to increase. Consumption of wines and spirits is often an integral part of meals and for some, is as important as the meal itself. Likewise, retail sales of wine and spirits is a dominant industry throughout the world. To achieve brevity and flow, the term wine is used throughout this document to mean wine, spirits, or any alcoholic beverage.

While the consumption and purchase of wine is widespread and popular throughout the world, numerous drawbacks exist in the wine and spirits industry. One such drawback arises as a result of the overwhelming variety of wine that are available for consumption. From a consumer's point of view, it is often difficult to discern the suitability or determine ones preferences about a wine without ordering or purchasing the wine, at which point the purchase has been made and, due to the nature of wine, the purchase can rarely be returned or exchanged after sampling. While it is possible to obtain information regarding a wine from a magazine or at a wine tasting event, these sources are often expensive or unavailable to consumer. Moreover, numerous consumers find it difficult to remember the particular data about a wine at the time of purchase.

As is commonly understood, restauranteurs have attempted to remedy this problem by printing and providing a wine list to their patrons. Although some restaurants offer a wine list, the wine list may be difficult to read in a dimly lit restaurant or offer little valuable information regarding the wines that are available, such as a wine's rating or character. The restauranteurs may be severely limited in the amount of space available to describe each wine and one may prefer a more detailed description of the wines offered. Moreover, changes to the wine list may necessitate a costly and time consuming reprinting of the wine list.

A further drawback presented to a restauranteur engaged in the sale of wine is maintaining inventory. To maintain customer satisfaction, the restauranteur should accurately maintain his inventory so that offered wines are available. In contrast to other commodities, wines are stored in cool and dark environments and sold by the bottle. As a result, the process of maintaining inventory by regularly physically counting each bottle of available wine is a time consuming and undesirable task. Most restaurant wines are not bar coded and scanned.

As a further drawback, presently an efficient system does not exist to track the type of wine sold, the price at which the wine is sold, and information about the purchaser or the time of purchase. Consequently, marketing of wine is as often undertaken without supporting data.

There exists therefore, a need for an improved method and apparatus for providing information regarding wine to a consumer, receiving information from a customer, and tracking wine transaction related information and statistics.

### SUMMARY OF THE INVENTION

The method and apparatus disclosed herein may be configured to assemble product information for display to a user on an information display device. The user may selectively enter product parameters or qualifiers to view desired product information. The product information may be stored on the information display device or downloaded from a server computer. The user may view various product information and make product selections based on the product information. As described below, various other functionality is enabled by the method and apparatus disclosed below.

In one embodiment, a system for providing product information to a user and for collecting user information is disclosed. The system comprises a first server configured to store product information and receive user information. A mobile information display device may communicate with the first server and include a transceiver configured to communicate with the first server, a display configured to display product information to the user, a user interface configured to receive information from the user, a processor configured to execute machine readable code, and a memory configured to store machine readable code. The machine readable code may be configured to provide product selection data to the user, provide product review data to the user, and provide product recommendation data to the user. In one embodiment, a second server is located remotely from the first server and the second server is configured to provide product information to the first server and collect user information from the first server. In one embodiment the product information comprises information concerning wine. In another embodiment the machine readable code is further configured to present a survey to the user and provide the survey results to the first server. One exemplary survey may be offered by Zaget to obtain information about the user or the user's preferences. In one embodiment the machine readable code is further configured to allow the user to order a product for consumption during a event.

It is further contemplated that the system disclosed herein may be configured to facilitate ordering an alcoholic beverage. Such a method would comprise entering a first alcoholic beverage qualifier into an information display device and thereafter, viewing a list of qualifying alcoholic beverages on a display. After viewing the user is able to request information regarding one or more of the qualifying alcoholic beverages and select an alcoholic beverage from the list of qualifying alcoholic beverages, wherein selecting results in the alcoholic beverage being ordered and served. In one embodiment the method further includes entering a second alcoholic beverage qualifier into an information display device.

In one embodiment the alcoholic beverage comprises wine. It is further contemplated that the first alcoholic beverage qualifier may comprise a serving size of the alcoholic beverage and the second alcoholic beverage qualifier may comprise a type of the alcoholic beverage. In one embodiment the requested information comprises requesting tasting reviews of an alcoholic beverage, while in another embodiment the method further includes entering a user identifier to gain access to user specific information such that the user specific information comprises data regarding alcoholic beverages preferred by the user.

As an alternative, the invention may be configured to collect data regarding product selections by a consumer during the product purchasing process. Such an exemplary method may comprise presenting a two or more product choices to the consumer on a display of an information display device and receiving a request for additional information regarding a product. The information display device may record each product that the consumer requests additional information and display additional information to the consumer regarding the products for which additional information was requested. Next, the method records which products are purchased by the consumer. In one embodiment this operation may be further configured to present a survey to the consumer on the display for completion and collecting survey results after completion. In another embodiment the operation further includes presenting a personal information questionnaire to the consumer. It is contemplated that in this embodiment the product may comprise wine and the additional information may comprise wine characteristics. The step of recording may comprise storing in a memory of a information display device and subsequently transmitting to a server.

It is also contemplated that the system and the method realized therefrom may be embodied entirely or at least partially as computer software. As such, a computer program product is configured comprising a computer useable medium having computer program logic recorded thereon for providing and collecting product information from a user. In this embodiment, the computer program code logic is configured to transfer product information from a server to a mobile information display device. The computer program code logic is configured to provide product information to a user on a display of the information display device. In addition, the computer program code logic is configured to determine a product selected by the user. Additional computer program code logic is provided and configured to display additional information regarding the product selected by the user on the display of the information display device and the computer program code logic may be configured to subsequently receive product ordering information from the user.

In one embodiment the product information comprises information regarding alcoholic products. In another embodiment the system further comprises computer program code logic configured to display personalized user information recorded by the user wherein the personalized user information comprising product preferences. In yet another embodiment, the computer program code logic is configured to transmit the product ordering information from the information display device to the server.

It is also contemplated the system disclosed herein may be configured to enable maintaining inventory of wine at a point of sale location. Such a method includes the steps of recording a wine identifier during a wine sale transaction at a point of sale location and transmitting the wine identifier associated with the wine sale transaction to a server. Thereafter it is contemplated that a compilation of wine identifiers at the wine sale is performed at the location server. This data is also transmitted to a hub server. A further step includes processing the compilation of wine identifiers to a hub server to facilitate the shipment of wine to the point of sale location.

In one embodiment the point of sale location comprises a location selected from the list comprising of a restaurant, a retail store, and a lounge. In one embodiment the wine identifier comprises a bin number. It is further contemplated that processing comprises determining which wines were sold at the point of sale location and generating an order for the wines that were sold at the point of sale location. The following is a detailed description of the invention.

### DESCRIPTION OF THE DRAWINGS

FIG. 1 illustrates a block diagram of an example embodiment of the invention.

FIG. 2 illustrates a block diagram of a portable communication device for use with the example embodiment shown in FIG. 1.

FIG. 3 illustrates an exemplary configuration of a main screen display.

FIG. 4 illustrates an exemplary configuration of a product selection screen display.

FIG. 5 illustrates an exemplary configuration of a product information display screen.

FIG. 6 illustrates an exemplary configuration of a tasting notes page.

FIG. 7 illustrates an operation flow diagram of an exemplary method of product information download and product ordering.

### DETAILED DESCRIPTION OF THE INVENTION

A method and apparatus for providing and collecting product information is disclosed. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

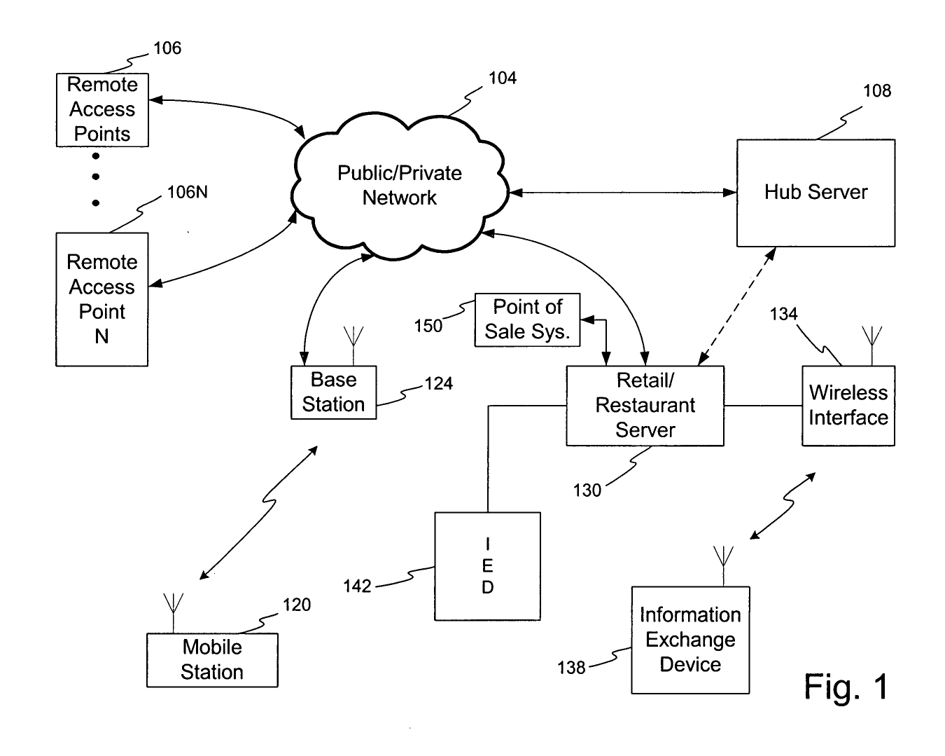

FIG. 1 illustrates a block diagram of an example embodiment of the invention. It should be noted that this is but one example embodiment and other embodiments, which do not depart from the scope of the invention, may be enabled. In addition, the various features described herein may be enabled alone or in combination. As shown in FIG. 1, a computer network, illustrated as the public/private network 104, connects various systems. Although illustrated as the Public/private Network 104, it is contemplated that any data communications network capable of connecting two or more computing device is acceptable.

A hub server 108 is also accessible via the network 104. The hub server 108 comprises any type of computer system capable of storing data and providing data to one or more users over a computer network. Processing may also occur at the hub server. In one embodiment the hub server 108 includes data base systems to store data regarding wine, user information, or wine consumption or purchase patterns. The operation and content of the hub server 108 is described in more detail below.

Also connected to the Public/private Network 104 or directly to the hub server 108 is a retail/restaurant server 130. While the retail/restaurant server 130 may be located at any location, it is contemplated that in one embodiment the retail/restaurant server is located at a restaurant or a larger establishment having numerous restaurants, or a retail location configured to sell or distribute wine or spirits. The term wine should be interpreted to cover any beverage such as wine, beer, distilled or brewed alcohol, or any type of spirits. In other embodiment the method and apparatus described herein may be used for products other than wine. These products include, but are not limited to, cigars, cheese, flowers, various types of food, fragrances, perfumes, desserts, caviar, sushi, coffee, or tea. The hub server 108 and retail/restaurant server may contain memory, hard disk drive storage, user interface, display apparatus, communication systems and other apparatus commonly found within servers or other such equipment.

In communication with the retail/restaurant server 130 is a wireless interface 134. The wireless interface 134 serves to facilitate communication between one or more mobile information exchange devices 138. It is further contemplated that a hardwired information exchange device 142 may also communicate with the retail/restaurant server 130. The wireless interface 134 may comprise any type communication device capable of communicating over a wireless channel. Any type wireless transmission system may be implemented including, but not limited to, radio or other frequency or electromagnetic energy, optical, and infrared type communication. Moreover, the wireless communication may occur under any type standard or protocol, such as AMPS, IS-95, GSM, COPD, Mohitex, Ardis, IEEE 802.11, GPRS, UMTS, Bluetooth and the like.

In one embodiment the information exchange device 138 does not communicate over a wired or wireless link but is instead pre-loaded with the desired information and software to achieved the functionality disclosed herein. In such an embodiment the information exchange device 138 is configured to be pre-loaded with the desired information via a temporary hardwired connection, such as to a server, or provided the information via a media, such as flash memory, CD-ROM, DVD-ROM, or the like. The media would be read by an interface in the information display device that is configured to read data or write data, or both, to a media. Thus each information exchange device 138 would maintain is portability without the need to establish a wireless network or a hardwired network. It is further contemplated that appropriate user tracking and monitoring may be stored in the information exchange device 138 during use and downloaded for use at a later time by an administrator.

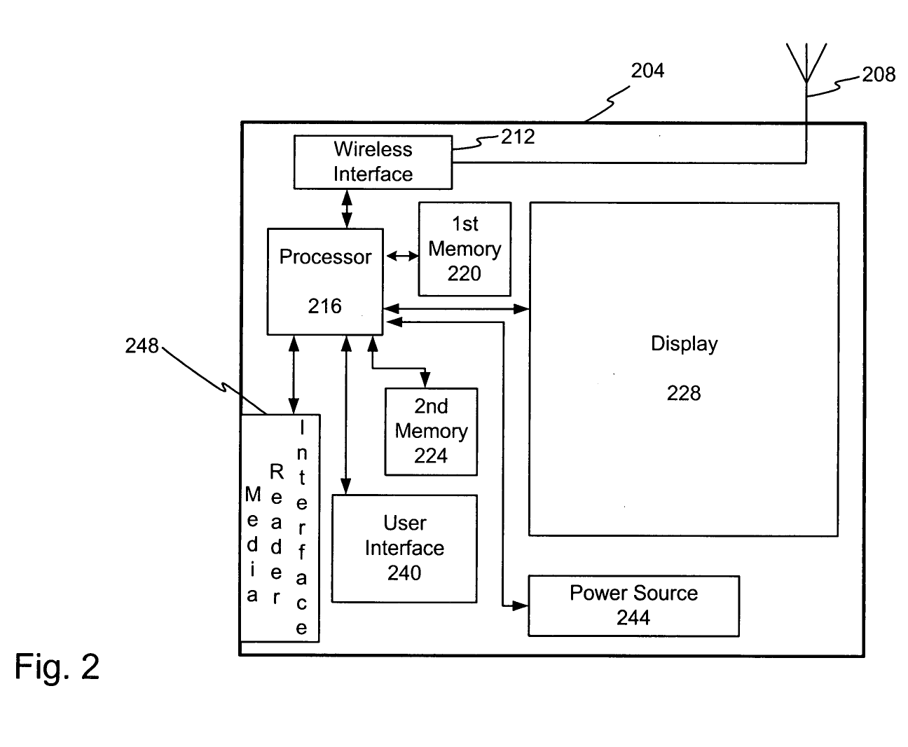

The information exchange devices (IED) 138, 142 comprise electronic devices configured to receive and display information from the server 130 or hub server 108 in response to automatically occurring scripts or input from a user. In this manner the user of the information exchange devices 138, 142 may interactively obtain information regarding wine from the server 130 or hub server 108. Similarly, the information exchange devices 138, 142 may be equipped to obtain information from a user and provide such information to the server 130 or hub server 108. The configuration and operation of the information exchange devices 138, 142 is discussed below in greater detail in conjunction with FIG. 2.

Connecting to the network 104 is one or more remote access points 106. Any number of remote access points 106 may be provided as designated by remote access point 106N. In one embodiment the remote access points 106 are physically connected to the network 104. Examples of the access points include home computers connected to the Public/private Network 106 or to kiosks or other similar devices with access to the Public/private Network 104. Remote access points 106 may communicate via a wireless link. Through one or more access points 106 a remotely located user may access the data available on the hub server 108 or input data into the hub server 108.

One or more mobile stations 120 may also connect to the hub server 108 or the retail/restaurant server 130 via a base station 124 and the network 104. The mobile station 120 may comprise a cellular telephone, personal digital assistant with wireless communication capability, wirelessly equipped laptop computer, or other similar device. As is understood, it may be desirable to access such information while mobile or in transit to or from a destination, such as on the way to a meal at a restaurant or to a golf course, club or country club.

It is further contemplated that the retail/restaurant server 130 may communicate with a point of sale system 150. Operation and interface between the retail/restaurant server 130 and the point of sale system 150 is described below in more detail.

FIG. 2 illustrates a block diagram of an information exchange device as shown in the example embodiment of FIG. 1. The information exchange device 204 may comprise any type device capable of receiving and displaying information, to one or more users, received from a remote location. In one embodiment the information exchange device 204 comprises a tablet device. In other embodiments it is contemplated that the information exchange device 204 may comprise a personal digital assistant, laptop computer, a kiosk, a desktop computer, web enabled cellular telephone, tablet PC, web pad, or a MIRA Internet appliance.

As shown in FIG. 2, the information exchange device 204 is embodied to communicate over a wireless network. Accordingly, the information exchange device 204 includes an antenna 208 which connects to a wireless interface 212. The antenna 208 and wireless interface 212 operate in unison to receive signals transmitted from a remote location. As described above, other systems and methods for communication with a remote location are possible. The wireless interface 212 may perform decoding, demodulation, and other processing as necessary to receive and transmit information with a remote location.

A microprocessor 216 or other computing device such as a DSP, ARM, ASIC, or any type of processor, connects to the wireless interface 212 to perform analysis and processing on data. The processor 216 also connects to or communicates with a first memory 220, a second memory 224, a display device 228, a user interface 240, and a removable media reader 248. The first memory 220 and the second memory 224 may comprise any type memory capable of storing data. In various embodiments the memory 220, 224 may comprise RAM, ROM, a hard disk drive, flash memory, optical memory, CD or DVD ROM, or a CD-RW media. In one embodiment the memory 220, 224 is configured to store any or all of data, software code and programs, video data, pictures, graphics, machine readable code, and processor executable logic code. The display 228 may comprise any type system configured to display information to a user. In one embodiment the display 228 incorporates touch screen capability for use by a user with a stylus or other pointing device. In one embodiment the information exchange device 138, 142 includes a microphone or other similar device in combination with a voice recognition system configured to allow a user to provide voice commands to the information exchange device to thereby control navigation or other aspects of operation. The user interface 240 may optionally be included to provide access to additional systems for a user to enter information from the information exchange device 204. The user interface 240 may comprise a track ball or mouse type device, one or more keys, buttons, a keyboard, microphone, speaker, voice recognition system, pointing device, or any other device or system capable of receiving input from a user. The media reader 248 comprises an interface or drive capable of reading, writing, or interfacing with a media. The media may comprise ROM, a hard disk drive, flash memory, optical memory, CD or DVD ROM, or a CD-RW media. In one embodiment the media reader 248 is configured as an input/output port to receive and send data over a hardwired connection. In such a configuration the media reader configured as a port may comprise a USB port, Firewire (IEEE1394) port, serial port, or parallel port.

A power source 244 connects to the processor 216 to provide power for operation. Although not shown it is contemplated that the power source 244 may also connect to other systems or devices of the information exchange device 204 as necessary to achieve operation and as understood in the art.

In operation the information exchange device 204 receives information over the antenna 208 and the wireless interface 212. Upon receipt the processor 216 may process the data to reformat the received data for viewing on the display 228 or for use by a user. The data received by the processor 216 via the antenna 208 and interface 212 may be stored either permanently or temporarily in the first memory 220 or second memory 224 or both. Alternatively data may be received via the media reader 248. As an advantage of the system shown in FIG. 2, the data used for display to a user may be dynamically received over the wireless link when requested by a user or intermittently received on an update basis to achieve faster operation. It is further contemplated that the information exchange device may also be loaded with data, such as through a media reader 248 configured as a port, and thereafter serve as a stand alone system without interface with a server.

The information exchange device 204 may be further configured using the systems shown in FIG. 2 to receive user input. A user may provide user input to the system via the user interface 240 or a touch screen equipped display 228. Any type of information may be received from a user and the type and use of such information is discussed below in greater detail. User information may be stored in the memory 220, 224 or uploaded to a server for processing and further storage. Other information in addition to or instead of user information may also be obtained by the information exchange device 204.

It is contemplated that the information exchange device 204 may execute software to provide an interactive experience to a user. In one exemplary embodiment the system is configured to provide information about and collection information in conjunction with spirits, such as wine. In other embodiments the method and apparatus described herein may be configured to offer information about cigars, food, such as caviar, cheese, flowers, fragrances, and the like. One example of a device 204 is the ProGear tablet available from Sonicblue located in Santa Clara, Calif.

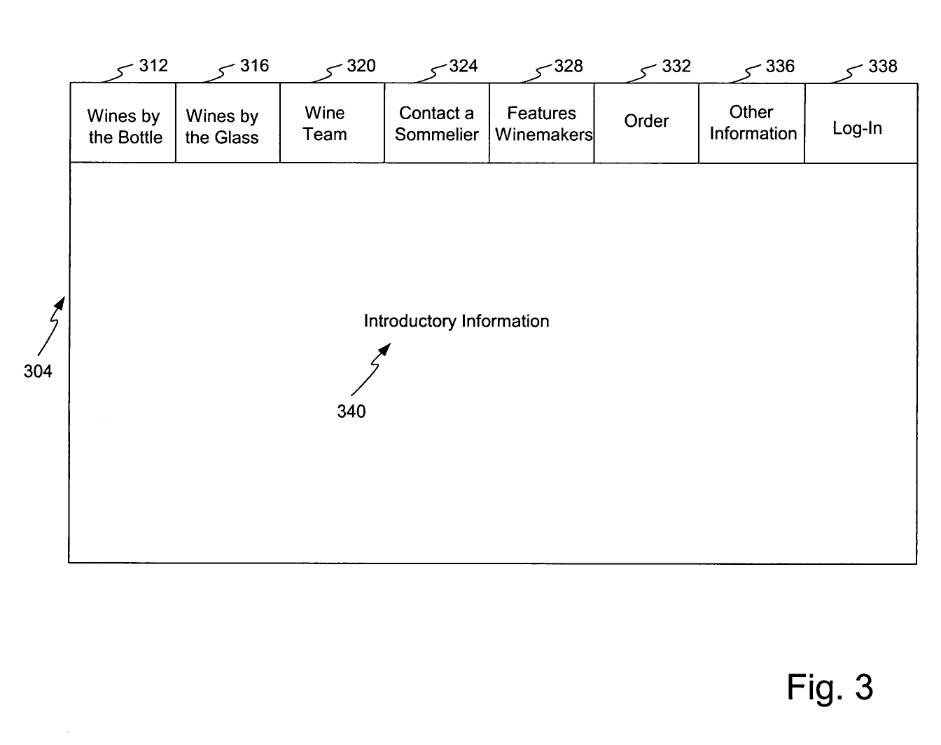

In reference to FIGS. 3-7, a discussion is provided of an exemplary software package configured to provide features described herein. It is contemplated that if provided the following information one of ordinary skill in the art will be able to enable such a system. As a result, the following discussion focuses on features variations without delving into the programming concepts. As shown in FIG. 3, an exemplary main page screen display as might be shown on the display 228 (FIG. 2) is provided. This particular screen configuration is provided for purposes of discussion and other configurations or other layouts may be adopted without departing from the scope of the invention. In the exemplary display various pull down menus enable the functionality as shown. In an exemplary screen shot, potential pull down menus or links to other information are shown by the headings Wine by the Bottle 312, Wines by the Glass 316, Wine Team 320, Contact a Sommelier 324, Featured Winemakers 328, Product Ordering 332, other information section 336, and Log-In section 338. Also located on a main page is introductory information 340.

In general, the screen display, shown in FIG. 3 in conjunction with the hardware shown in FIGS. 1 and 2 is configured to enable a user to research, order, select, or comment upon a wine. Further a user may order product to be shipped to their home, request contacts from other individuals, or perform a variety of other activities. Each subject matter category is discussed below in more detail.

The wines by the bottle selection 312 allows a user, upon selecting this option such as by touch screen or pointing device selection, to access available wines categorized by the bottle. By the bottle is in contrast to by the glass, discussed below in more detail. In one embodiment, the wines by the bottle may be numerous and subcategory selections may occur such as a selection between sparkling, white, rose, red, sweet, fortified, or other categories. Thereafter, a sub-sub-category selection may be provided to further refine the search, such as a country identifier, or region, or grape variety, or wine style, or producer. The wines by the glass selection 316 displays wines that are available by the glass.

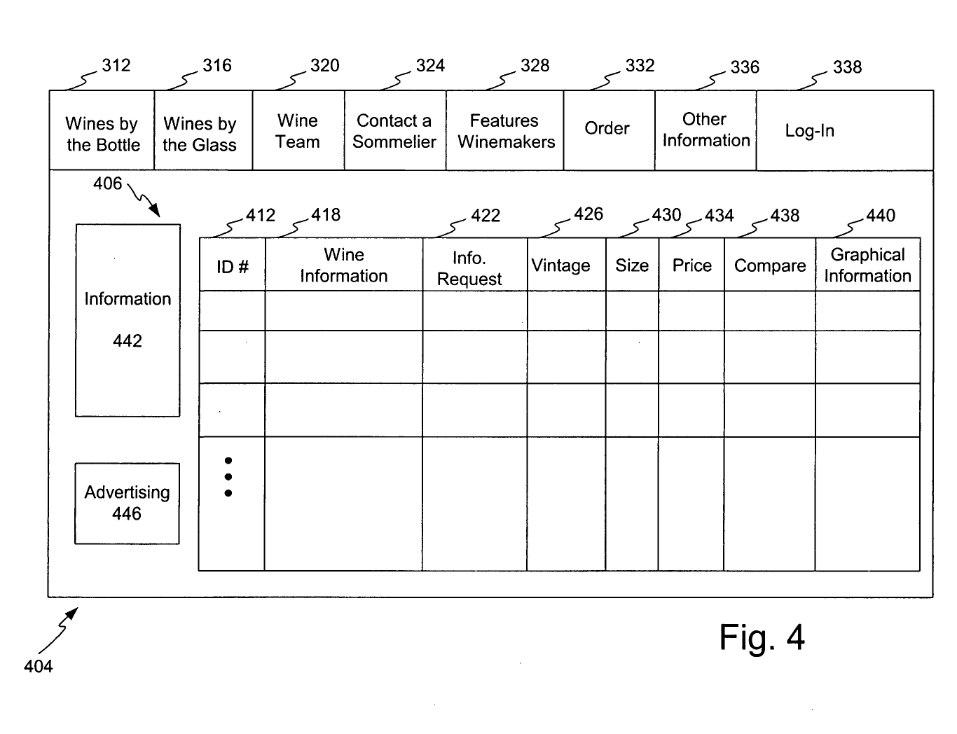

FIG. 4 illustrates an example screen content of a display page 404. As shown the display page 404 comprises an information display table 406 configured to display the requested information. Structures other than a table may be displayed. In one embodiment the table 406 consists of a ID # column 412, a wine information column 418, an information request column 422, a vintage column 426, a bottle size column 430, a price column 434, a comparison select column 438, and a graphical information display column 440.

The identification number column 412 is configured to display information containing an product, in this example, a wine identification number. The wine information column 418 comprises a column configured to display the type or brand of wine. The information request column may be configured to facilitate the request of additional information by the user, such as by telephone, e-mail, or mail address input. A request for follow-up contact may be made by the user receive additional information such as where to buy the wine, which may depend on the users shipping location, web links to obtain information about the wine. This provides an opportunity for the customer to request more information.

In another embodiment an icon is displayed in this column if additional information is available regarding this product. The additional information maybe accessed by selecting or clicking on the icon. The vintage column 426 comprises a column configured to contain information regarding the vintage or year of a wine. The size column 430 may contain data regarding the size of a bottle or container. The bottle size may comprise 375 ml, 750 ml, 1.5 ml, magnum, double magnum, jeroboam, rehoboam, methulsulum, 6 liters, and 9 liters, or any other size designator. The price column 434 may contain pricing information for the wine and the compare column 438 may contain check boxes, a plurality of which may be selected, to compare two or more different entries, such as two or more wines. It is contemplated that various other categories may be offered and the categories (column content) will vary based on the subject matter selected for use with the system.

A graphical information display column 440 is configured to display information, in a graphical format, regarding one or more characteristics of the wine. Display may occur in table form, bar graphs, pie chart, or any other graphical display as contemplated to provide information to the user. Thus, the user may then review the list of wines and quickly view the graphical information column 440 to determine to what degree the listed wines have the desired characteristics.

Also shown on the information display page is an additional information display section 442 and an advertising display section 446. These areas are available to generate additional revenue via advertising or provide a more desirable presentation to the client.

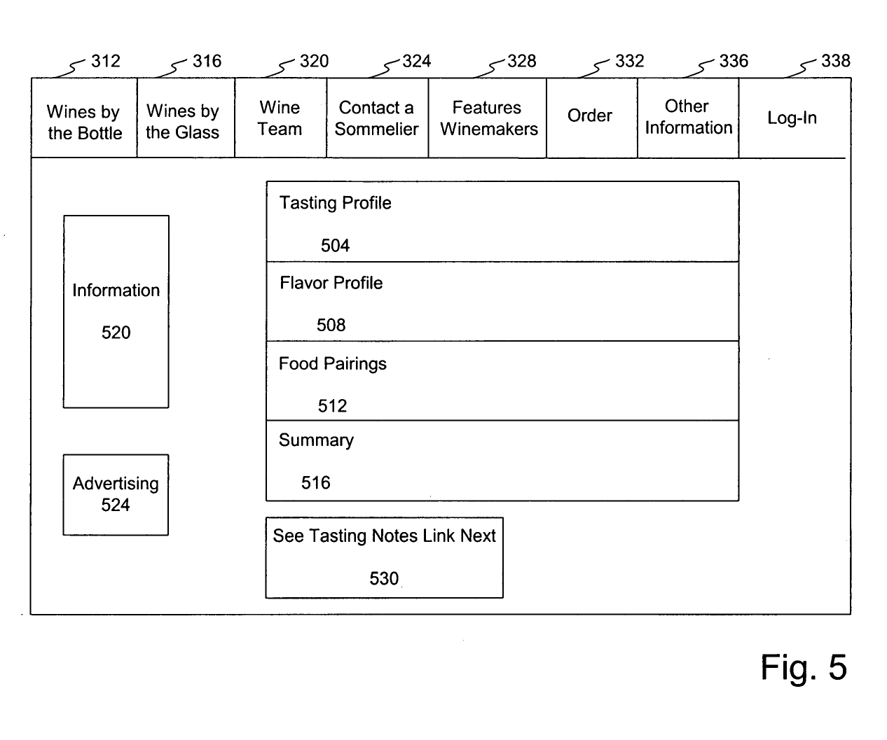

As described in conjunction with information request column 422, FIG. 5 illustrates exemplary display content of additional information that may be displayed when requested, such as by clicking on an icon. As shown in relation to the exemplary subject matter of wine, the additional information comprises a tasting profile 504, a flavor profile 508, a food pairings section 512 and a summary section 516. In one embodiment the tasting profile 504 comprises a section containing information regarding the taste of the selected wine, or information regarding what other professional tasters have indicated about the wine. In one embodiment the flavor profile 508 comprises a section containing information regarding the flavor of the wine. Various flavor descriptors or categories may includes the modifiers crisp, soft, juicy, jammy, bold, oaky, fruity, other terms descriptive of wine.

The food pairing section 512 contains information regarding which types of food may preferably be consumed with the selected wine. It is contemplated that in other fields of use, other subject matter may be contained in a pairing section. It is further contemplated that menu items may be input by a user and the system will propose wines that will best complement the menu items. In one embodiment the method and apparatus described herein may be used with cheese and as a result section 512 may deal with cracker pairings or wine pairings for use with wine. Hence these headings should be interpreted broadly.

In one embodiment the summary section 516 may comprise general or supplemental information regarding the wine or other topic. Other information may be provided in this section including, but not limited to, information about the winery, other people who drink this wine, wine ratings, or wine style. The sections 504, 508, 512, 516 may include text, graphics, or both. In one embodiment the actual label of the wine or picture of the bottle is shown to aid in identification of the bottle at a retail location at a later date.

Also shown on the FIG. 5 is a supplemental information display section 520 and an advertising display section 524. These areas are available to generate additional revenue via advertising or provide a more desirable presentation to the client. Additional information may be provided at these or any other location. The advertising section may provide a link to another business partners site. The claims which follow are not limited to a particular screen configuration. These sections 520, 524 may differ in content as compared to the similar sections shown on FIG. 4.

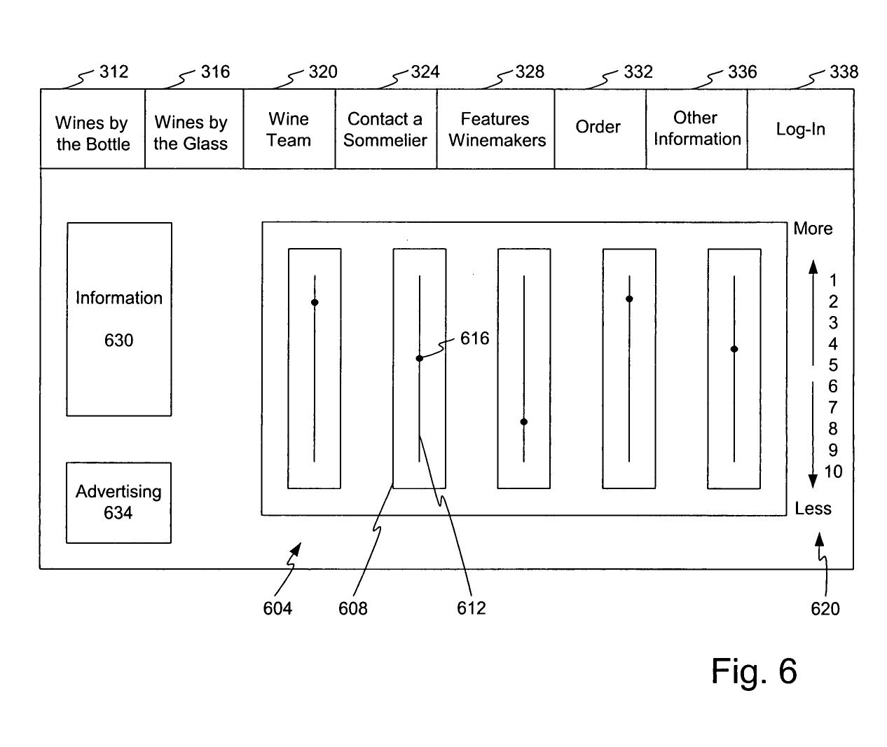

It is further contemplated that the display of FIG. 5 may include a link or an ability for the user to obtain additional information. In this example embodiment a tasting notes link 530 is provided as shown. FIG. 6 illustrates an exemplary tasting notes page. In one embodiment the tasting notes page comprises a rating section 604 containing one or more individual category guides 608. In the field of wine, the category guides may comprise any subject matter as may be developed by one of ordinary skill in the art to describe the wine or provide additional information regarding the wine, including but not limited to, personality, oakiness, fruitiness, crispness, sweetness, body, style, softness, or other factors as described herein or that are known in the wine industry.

Within each category guide 608 is a rating scale 612 with a rating identifier 616. The location of the rating identifier 616 in relation to a rating scale 620 provides additional information regarding the wine for that particular category guide 608. Other ratings scales 612 may be opted for use.

Also shown on the FIG. 6 is a supplemental information display section 630 and an advertising display section 634. These areas are available to generate additional revenue via advertising or to provide a more desirable presentation to the user. These sections 630, 634 may differ in content than the similar sections shown on FIGS. 4 and 5.

Returning to FIG. 3, the link to wine team 320 comprises resources for the user to obtain additional information regarding the individuals, company, or entity responsible for the content of the information display device. For example, some subject matter may be subjective and as a result a user's reliance on the information may be dependent upon the source of the information. Wine reviews, as in other reviews, such as music reviews, or movie reviews may depend in part on the reviewer. In addition, links to well known wine reviews may be provided such as those contained in the Wine Spectator, the Wine Enthusiast, or those of Robert Parker.

Also shown in FIG. 3 is the Contact a Sommelier 324 section configured to allow a user to request that an expert or other individual or entity contact them. Various means may be provided to facilitate the contact including a table-side visit, an e-mail, regular mail, telephone, cell, fax or other form of contact. As with all information provided to the user and collected from the user, the contact may also be useful for the purpose of additional marketing or the generation of sales contacts. In one embodiment the contact to the sommelier section 324 may be used to reserve a bottle or glass of wine prior to being waited on at an establishment or arriving. In such an embodiment a request may be made to the sommelier and the sommelier would have the bottle ready upon the arrival of the requesting party. This also provides the advantage of having a bottle reserved for the person via the systems described herein.

The featured winemakers section 328 comprises a link or access portal to additional information regarding the products or services offered by the entity, such as a user, utilizing the system described herein. In one embodiment section 328 provides access to additional information or advertising regarding one or more particular wine makers or vineyards. It is contemplated that various sub-menus may be presented to the user such as type of wine, red, white, sparkling, sweet, or location of the winery, or wine maker. As can be appreciated, items or products other than wine may have different sections designed to serve a similar purpose.

The product ordering section 332 may comprise a section, link or other access configured to allow a user to order product. In one embodiment this section 332 facilitates a user ordering product from a restaurant or lounge in which they are currently located. In another embodiment this facilitates a user ordering product from a retail location to be delivered at a later date. Because the information exchange device 204 may be configured as a portable device, it may be presented to a user at a table or other location to provide means for the user to research and order a product. The order may be relayed to a server or other location to achieve providing the ordered product to the user.

In one embodiment the product ordering section 332 may be configured to facilitate a user ordering product to be shipped to a specified location at a later date. Thus, after researching the product or sampling the product, any quantity may be ordered and provided to them. Information that may be collected or provided may comprise address information, billing information and shipping information.

The additional information section 336 may be configured to provide any additional functionality or additional information as desired. The information offered or collected at this subsection may dynamically change or remain constant. Example of additional topics that may be addressed at the additional information section 336 include but are not limited to information regarding a restaurant, winery, lounge, or other area where the wine is served or offered, video content on any topic of interest including in person interviews, wine making procedures, wine tasting tips, or other events or opportunities at a location, such as gaming guides at a casino, or a wine information or education guide.

It is further contemplated that user surveys may be provided or accessed using the method and apparatus described herein. Hence a survey may be provided to a user. It may be desirable to obtain feedback from users regarding wine preferences and reasons for selecting a wine. This information, when combined with demographics of the user would be valuable to wine distributors and wine makers. The survey may be confidential, through use of the electronic format described herein, to further increase the survey's value. The survey may also include feedback regarding the place where the survey was taken, such as a restaurant, a lounge or other event.

The log-in section 338 is provided to facilitate a user entering a password or other identifier to gain access to a specialized portion of the information database or to gain access to a user's personal account, such as a personalized electronic wine cellar. In one embodiment the method and apparatus described herein includes capability to personalize an account for a user such that the user may enter identifier information, such as a password, to gain access to their account information. In one embodiment a user may create, access and update their account via a remote access point. Any type of personal information may be input into their account for access at a later time. Similarly, a user's personal account may be accessed and updated at location other than at a remote access point.

A user's personalized wine cellar may contain information such as but not limited to a user's personal wine favorites, which wines they have sampled, wine dislikes, preferred wineries, preferred wine characteristics, express wine ordering routines, preferred restaurants, specialized news or information delivery tailored to a particular user, preferred vintages, questionnaires, user tailored advertising, and other such topics. It is further contemplated that access to the actual inventory of the restaurant or winery may be provided via the user's personal account or other portion of the system described herein. In one embodiment a user may receive advertizing, in-store coupons, gifts, or other incentives based on their profile.

In one embodiment the disclosed method and apparatus is configured to integrate with a point of sale system to facilitate inventory tracking and automated product ordering. In the example product environment of wine, the system would include communication capability between a point of sale system. In one embodiment the sale of product, such as wine would be relayed to the retail/restaurant server where such information would be added to the information collected by the information collection devices. It is further contemplated that additional information may be provided such as patron tracking to determine if the product was purchased after dining in a restaurant having the information display device, or time of sale, price of sale, product location when the product was sold, or even quick survey results from the consumer. As a result of the sales of product being tracked through the point of sale system and provided to the retail/restaurant server the product ordering features, which are described below, may be utilized. This operation may occur in real time or periodically, such as at the end of a day. In this manner real time inventory control may be achieved and the entire product tracking system may reflect accurate product counts. Moreover, it is contemplated that if inventory is low or gone, then the system will no longer provide product information to user via the information display device to prevent patrons from expecting a product that is not available. This is a benefit over prior art hard copy wine lists which may not accurately reflect actual inventory levels which thereby leads to consumer disappointment.

It is further contemplated that numerous forms of advertizing or product promotion may be integrated with the method and apparatus described herein. As discussed above, advertising may be displayed on any of the various displays or links discussed above. It is further contemplated that the advertising may be tailored to promote products sold within the establishment or resort or other or other locations within the establishment or resort. Products, services or locations other than the product featured on the information display device may be the subject of the advertising. In the embodiment having wine as the primary product, the advertising may be tailored to a particular wine selected based on factors such as winery location, price, type of wine, real time survey results, or user's address, a system's location, or any other aspect as may contemplated by one of ordinary skill in the art.

It is further contemplated that a user's system use and ordering information may be collected during operation to determine wine selection patterns and preferences. In addition, survey results including user address or contact information may be collected and used to direct advertising or promotional information to users or groups of users. By way of example, it may be highly desirable to obtain and record information during use of the information exchange device for future use by sales, marketing, and advertising personnel. Such information may include but is not limited to which wines sell and for what price and at what time of day or what date, which wines are in the wine list, i.e. displayed on the device, when the wine is off of the line list, when a wine sells out, what the user is looking at and clicking on when using the information exchange device, how often a user stays at a link, when wines are ordered with what menu items, how much a wine is priced at, when personal information is provided and what type of display attracts a user to a wine and what the basis is for ordering a wine.

Retail Component Features

Also associated with the method and apparatus described herein is a retail component that may exist in addition to the environment of use of a restaurant. It is contemplated that the system described herein may be implemented for use at a retail location such as a retail sales location, grocery store, or winery. In such an environment a user may comprise a consumer investigating various products, such as wine, to gain information sufficient to make an informed decision for a retail purchase. As can be appreciated, selection of certain products can be confusing to purchasers not familiar with a product line or not experienced in a field. By providing the content and information opportunities described herein a consumer may gain information previously unavailable or which previously required a physical hardcopy guide, which cost money and existed only in paper form. Often a consumer did not have the physical guide with them or did not subscribe. This had the effect of discouraging may potential consumers from the market place and reduced their likelihood to purchase a new or different product. In one embodiment a kiosk is located in a wine sale area within a retail location and access provided for a consumer to access the various types of information.

In one embodiment a retail location administrator may download information from a server, which may be located out of sight of the retail displays, to the kiosk. Downloads to the server from a hub server (element 108, FIG. 1) may be made as described below. Communication between the kiosk and the retail server may occur over a wireless link, such as when utilizing the 802.11 wireless protocol.

It is further contemplated that a user's profile may be accessed at a retail location in a manner similar to that discussed above for in an environment of a restaurant. As a result, a user may enter preferred wines into their profile during a dining experience or at home via a remote connection to the hub server. Then, at a later time, the user may recall their personal account to access their preferred wine list. As a benefit to the user, the system may direct the user, in this case a user acting as a consumer, to the location of the desired product on the floor, such as by aisle and shelf number, to aid in locating the product. The user may receive timely price specials in various retail establishments proximal to his current location.

It is further contemplated that the retail aspects of the method and apparatus described herein may extend to on-line retail locations by tying in with the personal account capability and an ability to order wine, during a dining experience or during an event, from an online retailer. Similarly, direct sales from a winery may occur in a manner described herein. Credit card information, billing information, delivery information or other information may be stored for the user.

Training Features

In one embodiment the method and apparatus described herein is configured to serve as a training tool for workers, such as servers, waiters, retail workers, clerks, wine experts, or the like, or other individuals. In such an embodiment training modules may be downloaded as described herein or streaming content may be delivered to a home user, portable information display device, or a server. In one embodiment the trainee is quizzed or tested during or after the training to determine proficiency in the training materials. A certification process may be implemented to assure a degree of knowledge regarding the product being sold. Various associations may occur such as with a recognized body or authority of product knowledge. Access to the training may occur after a log-in process. Users may also have training privileges to encourage purchase of products after training or for marketing of the product. As an advantage, the retailer or restaurant owner is not responsible for the content and hence need only subscribe or participate in the services described herein to gain the benefits.

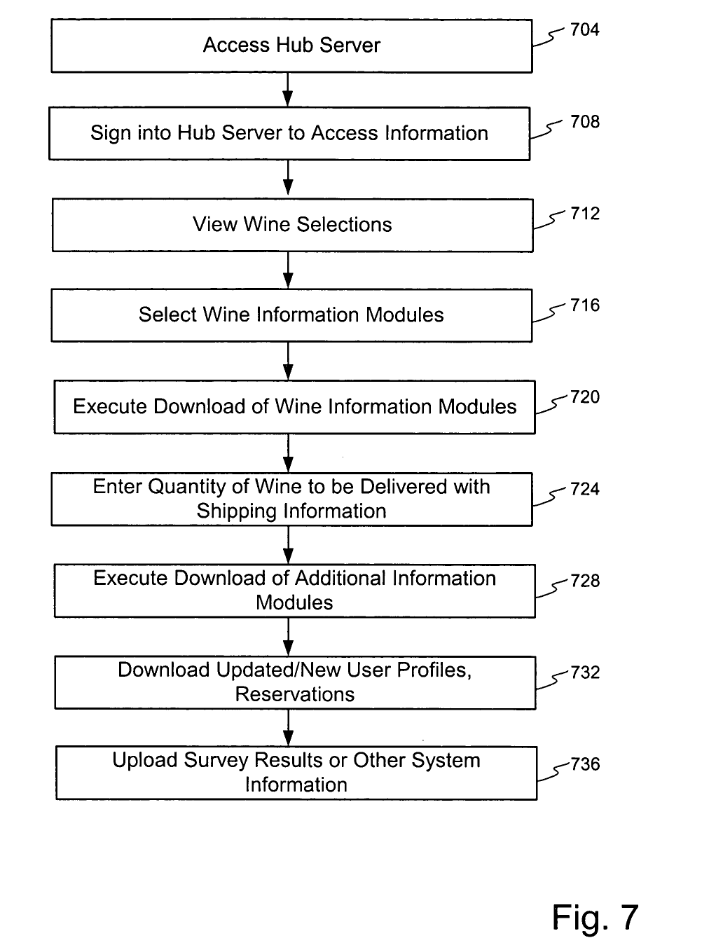

FIG. 7 is an operational flow diagram of an example method of updating or establishing content for an information exchange device or its associated server. This is an exemplary method of establishing content for system such as the one described herein. It is contemplated that in other embodiments other methods up updating or establishing content may be enabled. In one embodiment, a vast array of information, grouped and referred to as modules, may be stored at a hub server (element 108 of FIG. 1) and continually or periodically downloaded to a retail/restaurant server (element 130 of FIG. 1). It is contemplated that only the particular information needed at the retail/restaurant server will be transferred to the retail/restaurant server. At a step 704 an administrator accesses the hub server. The administrator may comprise any individual or entity responsible for maintaining content of the information exchange devices for users of the system described herein. Access may occur via a dedicated network connection or over a shared network such as through the Internet. In one embodiment, information may be mailed via CD-ROM or DVD ROM.

After accessing the hub server, a user may sign into the hub server at a step 708. This may be considered an administrative user's log-in process with use of a password or other identifier. At a step 712, the wine module selections are made available for viewing. In one embodiment, a wine selection is a wine that is supported by the hub server. In one embodiment, the wine, i.e. any product, may be available for purchase or delivery via ordering on the hub server. It is contemplated that the wine may be displayed in conjunction with one or more modules associated with each wine. Download of the modules may occur to provide content regarding the wine. Modules other than those associated with a particular wine may also be available for download. The modules contain information regarding a product and it is contemplated that the information of the module be displayed on the information display device to a user.

At a step 716, an administrator selects various wine modules and, at a step 720, executes a download process of the selected wine modules. The download process makes the information contained in the modules available on the retail/restaurant server and hence available to a user of an information exchange device.

It is further contemplated that at a step 724, an administrator may enter the quantity of wine to be delivered to a location, such as a location serving the wine that is identified by the downloaded wine information modules. Thus, as part of the information module download, the associated wine may also be ordered by the administrator to be delivered to any location, such as to a restaurant or retail location. Other wine, such as wine associated with previous downloads, may also be ordered at step 724. Shipping information, if not already present at the time of account establishment, may also be provided.

Thereafter, at a step 728, additional modules may be downloaded. These modules may comprise any subject matter including those described herein. At a step 732, the administrator may download updated or new user profiles or reservations. This may occur based on a user's ability to update or create personal account information via an on-line access such as from a dial-up account, home Internet access, or via a mobile device such as a web enabled cellular telephone or PDA. As a result of the administrator periodically downloading the new or updated user profiles and reservations such information will be available for the administrator and user when a user frequents an administrator's establishment. These downloads may frequently occur automatically so that the data is continually provided to administrators.

In one embodiment the information is downloaded in real time when requested by a user of the information exchange device from a server, such as the hub server. This insures that the most up to date information is available to the user. In addition, it is contemplated that the hub server may be accessed by multiple systems, i.e. multiple locations offering information exchange devices.

At a step 736, the administrator may upload survey results, or usage information, or other system information or product consumption information to the hub server. This provides a reverse flow of information from the retail/restaurant server to the hub server. This may occur in exchange for the service of downloading product information modules from the hub server. It is contemplated that the process of uploading information may operate in conjunction with a point of sale system or the ordering process of the information exchange device. Thus, the system may be configured to automatically track products sold via an electronic information exchange device and perform ordering based on this information. This provides an advantage over the prior art by reducing the burden of physically counting each wine bottle that was removed from inventory.

It will be understood that the above described arrangements of apparatus and the methods therefrom are merely illustrative of applications of the principles of this invention and many other embodiments and modifications may be made without departing from the spirit and scope of the invention as defined in the claims.

1. A wireless communication system configured to request and receive data from a data server, the system comprising:
a data server configured to store first data and receive user information;
a mobile information exchange device comprising;
an wireless interface configured to receive first data from the data server and transmit second data to the data server;
a display configured to display the first data to the user;
a user interface configured to receive second data from the user;
a processor configured to execute machine readable code;
a memory configured to store machine readable code, the machine readable code configured to receive first data from the data server and send second data to the server via the wireless interface.
